(19) United States
(12) Patent Application Publication
(10) Pub. No.: US 2011/0160390 A1
(43) Pub. Date: Jun. 30, 2011

(54) PROCESS FOR PRODUCTION OF POLYESTERS WITH LOW ACETALDEHYDE CONTENT AND REGENERATION RATE

(75) Inventors: Clive Alexander Hamilton, Swainby (GB); Robert Edward Neate, Guisborough (GB); Catherine Jane Coleman, Darlington (GB)

(73) Assignee: INVISTA North America S.ar.L, Wilmington, DE (US)

(21) Appl. No.: 13/057,412

(22) PCT Filed: Jul. 31, 2009
(86) PCT No.: PCT/GB2009/001895

§ 371 Date: Mar. 16, 2011

Related U.S. Application Data
(60) Provisional application No. 61/086,975, filed on Aug. 7, 2008.

(51) Int. Cl. C08L 67/02; C08G 63/91; B29C 45/00

(52) U.S. Cl. 524/599; 525/418; 525/421; 525/436; 525/434; 264/328.17

(57) ABSTRACT

The present invention relates to a process for producing a polyester comprising: (a) forming a polyester in a melt phase having an intrinsic viscosity of about 0.65 or more, provided that said forming is not by solid state polymerization; and (b) adding an anhydride to the polyester during the melt phase. The present invention also includes articles comprising a composition produced by processes of the present invention.

### FIELD OF THE INVENTION

The present invention relates to processes for the manufacture of polyester having low acetaldehyde content and regeneration rate.

### BACKGROUND OF THE INVENTION

Polyester resin, for example polyethylene terephthalate (PET), is typically manufactured using a two stage process whereby a base polyester is made to an intrinsic viscosity (IV) of 0.62 dl/g in a melt phase polymerisation (MPP) process followed by a solid state polymerisation (SSP) process to attain a final product IV of up to 0.82 dl/g. The MPP can be further sub-divided into two more stages namely i) the esterification process in which the esterification reactions are typically taken to around 95% conversion, and ii) the melt phase polycondensation process where the conversion is increased to over 99% and the IV reaches about 0.62 dl/g. In order to achieve reasonable yields polycondensation catalysts are employed. Typical polycondensation catalysts include antimony (Sb), titanium (Ti), zinc (Zn), and germanium (Ge). These are added to the MPP to catalyze the polycondensation reaction. The catalysts are typically added either to the esterification process or just before the polycondensation process.

In conventional polyester manufacture, anhydride compounds are added to stabilize the polymer against (i) thermal degradation in the polymer transfer line from the finishing reactor to the chipper, (ii) thermo-oxidative degradation in SSP, and (iii) thermal degradation during the injection moulding process. The anhydride compounds are typically added either at the end of polymerization prior to SSP or after SSP, chipping and drying, for example as described in U.S. Pat. No. 4,361,681.

The thermal degradation reactions result in the formation of acetaldehyde (AA). Acetaldehyde is routinely measured in the base polymer chip, the final product chip and more importantly in the injection moulded preform. For a given vinyl-end group (VEG) level, the formation of the AA by-product can be controlled by minimizing hydroxyl-end groups (HEG) and maximizing carboxyl-end groups (CEG).

Unfortunately, polyester manufactured using the above conventional processes can have unacceptably high AA content in the preform. Therefore, a need exists for improved AA regeneration control and reduced AA content in a polyester resin.

### SUMMARY OF THE INVENTION

In accordance with the present invention, it has now been found that controlling the point and/or timing of addition of an anhydride compound in a polyester process without SSP can improve the hydroxyl-end group and carboxyl-end group levels, and as a result improve the AA content in the preform. The improvement of the AA content in the preform is achieved without the need for an AA scavenger. The present invention relates to a process for producing a polyester comprising: (a) forming a polyester in a melt phase having an intrinsic viscosity of about 0.65 or more, provided that said forming is not by solid state polymerization; and (b) adding an anhydride to the polyester during the melt phase. The present invention also includes articles comprising a composition produced by processes of the present invention.

### DETAILED DESCRIPTION OF THE INVENTION

The present invention can be characterized by a process for producing a polyester comprising: (a) forming a polyester in a melt phase having an intrinsic viscosity of about 0.65 or more, provided that said forming is not by solid state polymerization; and (b) adding an anhydride to the polyester during the melt phase. The intrinsic viscosity can be about 0.70 or more, for example about 0.75 or more or about 0.80 or more. The adding of step (b) can be after the forming of step (a).

The anhydride can be at least one member selected from the group consisting of a succinic anhydride, substituted succinic anhydride, glutaric anhydride, substituted glutaric anhydride, phthalic anhydride, substituted phthalic anhydride, maleic anhydride, substituted maleic anhydride and mixtures thereof. The substituted succinic anhydride can be at least one member selected from the group of methyl succinic anhydride, 2,2-dimethyl succinic anhydride, phenyl succinic anhydride, octadecenyl succinic anhydride, hexadecenyl succinic anhydride, eicosodecenyl succinic anhydride, 2-methylene succinic anhydride, n-octenyl succinic anhydride, nonenyl succinic anhydride, tetrapropenyl succinic anhydride, dodecyl succinic anhydride, and mixtures thereof. The substituted glutaric anhydride can be at least one member selected from the group of 3-methyl glutaric anhydride, phenyl glutaric anhydride, diglycolic anhydride, 2-ethyl 3-methyl glutaric anhydride, 3,3-dimethyl glutaric anhydride, 2,2-dimethyl glutaric anhydride, 3,3-tetramethylene glutaric anhydride, and mixtures thereof. The substituted phthalic anhydride can be at least one member selected from the group of 4-methyl phthalic anhydride, 4-t-butyl phthalic anhydride, tetrahydrophthalic anhydride, hexahydrophthalic anhydride, and mixtures thereof. The substituted maleic anhydride can be at least one member selected from the group of 2-methyl maleic anhydride, 3,4,5,6-tetrahydrophthalic anhydride, 1-cyclopentene-1,2-dicarboxylic anhydride, dimethyl maleic anhydride, diphenyl maleic anhydride, and mixtures thereof. The anhydride can have a melting point about 250° C. or less, for example about 225° C. or less or about 200° C. or less. The anhydride can be present at a concentration of from about 100 ppm to 10,000 ppm, for example from about 100 ppm to about 7,500 ppm or from about 100 ppm to about 5,000 ppm.

The forming of step (a) can comprise use of a catalyst. The catalyst can be at least one member selected from the group consisting of antimony, titanium, cobalt, zinc, germanium, aluminum and mixtures thereof or at least one member selected from the group consisting of antimony, titanium, zinc and mixtures thereof, for example antimony alone or a mixture of titanium and zinc. The catalyst can be present at a concentration in the range of from about 1 ppm to about 300 ppm by weight of the polyester, for example antimony can be present at a concentration in the range of from about 1 ppm to about 300 ppm by weight of the polyester or titanium can be present at a concentration in the range of from about 3 ppm to about 50 ppm by weight of the polyester or zinc can be present at a concentration in the range of from about 60 ppm to about 250 ppm by weight of the polyester or cobalt can be present at a concentration in the range of from about 50 ppm to about 250 ppm by weight of the polyester. In a mixture of titanium and zinc, the weight ratio of titanium to zinc can be in the range of from about 1:60 to about 1:2, for example about 1:20 to about 1:3 or about 1:10 to about 1:3.5.

The process of the present invention can further comprise step (c) of removing volatile components from the polyester.

Generally, the polyester can be produced from an aromatic dicarboxylic acid or an ester-forming derivative and glycol as starting materials. Examples of the aromatic dicarboxylic acid used in the present invention include terephthalic acid, isophthalic acid, 2,6-naphthalenedicarboxylic acid, phthalic acid, adipic acid, sebacic acid or mixtures thereof. The aromatic acid moiety can be at least 85 mole % of terephthalic acid. Examples of the glycol that can be used in the present invention include ethylene glycol, butanediol, propylene glycol, 1,4-cyclohexanedimethanol, or mixtures thereof. The primary glycol can be at least 85 mole % of ethylene glycol, butanediol, propylene glycol or 1,4-cyclohexanedimethanol.

Transesterification of the ester derivative of the aromatic acid, or direct esterification of the aromatic acid with the glycol can be used in the present invention. After polymerization to the desired IV, the polyester typically can be pelletized, dried and crystallized.

The polyester can be selected from the group consisting of polyethylene terephthalate, polybutylene terephthalate, polypropylene terephthalate, poly (1,4 cyclohexylene-dimethylene) terephthalate, polyethylene naphthalate, polyethylene bibenzoate, or copolyesters of these. For example, the polyester can be i) a polyethylene terephthalate, or a copolyester of polyethylene terephthalate with up to 20 wt-% of isophthalic acid or 2,6-naphthoic acid, and up to 10 wt-% of diethylene glycol or 1,4-cyclohexanedimethanol, ii) a polybutylene terephthalate, or a copolyester of polybutylene terephthalate with up to 20 wt-% of a dicarboxylic acid, and up to 20 wt-% of ethylene glycol or 1,4-cyclohexanedimethanol, or iii) a polyethylene naphthalate, or a copolyester of polyethylene naphthalate with up to 20 wt-% of isophthalic acid, and up to 10 wt-% of diethylene glycol or 1,4-cyclohexanedimethanol.

An embodiment of the present invention can be as follows. A 2:1 terephthalic acid (TA):ethylene glycol (EG) slurry can be injected into a natural thermosyphon esterifer operating at atmospheric pressure with a residence time of about two hours and a temperature range of about 280° C. to about 290° C. Ethylene glycol, cobalt acetate (not more than 150 ppm) and a titanium catalyst (not more than 50 ppm Ti) can be added to an oligomer line between the esterifer and the pre-polymeriser. The pre-polymeriser can be a vertical staged reactor or upflow pre-polymeriser (UFPP) operating under a vacuum in the range of about 20 mmHg to about 30 mmHg. The reactor residence time can be of the order of about one hour while operating in a temperature range of about 270° C. to about 290° C. The reaction products of the pre-polymeriser can then pass to a horizontal wiped-wall finisher operating under vacuum-viscosity control in a temperature range of about 270° C. to about 290° C. with a residence time of about one to about two hours. The IV target for this vessel can be about 0.5 dl/g to about 0.65 dl/g and require a vacuum of between about 1 mmHg and about 4 mmHg. Phosphorous (not more than 110 ppm) can be added to i) the finisher, ii) the transfer line between finisher/post-finisher or iii) the post-finisher. Finally the polymer can pass through a horizontal wiped-wall post finisher operating under vacuum-viscosity control in a temperature range of about 270° C. to about 290° C. with a residence time of about one to about two hours. The IV target for this vessel can be about 0.7 dl/g to about 0.9 dl/g and require a vacuum of between about 0.5 mmHg and about 2 mmHg. Anhydride compounds can then be injected into the post finisher transfer line downstream of the polymer pump but upstream of the polymer filter and chippers. Once the polymer has been solidified and made into particles (chips) it can then undergo a crystallisation/de-aldehydization process (deAA) whereby the chip crystallinity can be increased to at least about 35% (calculation from delta H (fusion)) and the residual aldehyde content can be reduced to less than about 1 ppm (to be equivalent with conventional SSP chip).

Another embodiment of the present invention relates to a process for producing a polymeric material comprising: (a) forming a polymeric material with an intrinsic viscosity of about 0.65 or more, provided that said forming is not by solid state polymerization; (b) adding an anhydride to the polymeric material in the melt phase; (c) removing volatile components from the polymeric material; (d) drying the polymeric material; and (e) injection molding the polymeric material.

Another embodiment of the present invention relates to a process for producing a polyester comprising: (a) forming a polymeric material with an intrinsic viscosity of about 0.65 or more, provided that said forming is not by solid state polymerization; and (b) adding an anhydride to the polyester during the melt phase wherein the forming of step (a) and adding of step (b) are performed at a temperature in the range of from about 270° C. to about 300° C. The forming of step (a) and the adding of step (b) can be performed at a temperature in the range of from about 290° C. to about 300° C.

The addition of a variety of additives is also within the scope of the present invention. Accordingly, heat stabilizers, anti-blocking agents, antioxidants, antistatic agents, UV absorbers, toners (for example pigments and dyes), fillers, branching agents, and other typical agents can be added to the polymer generally during or near the end of the polycondensation reaction. Conventional systems can be employed for the introduction of additives to achieve the desired result.

The present invention also includes articles made from the above manufactured compositions. Articles can be pellets, chips, sheets, films, fibers or other injection molded articles such as performs and containers, for example bottles.

### Test Methods

Measurement of Intrinsic Viscosity in Polyethylene Terephthalate—Intrinsic Viscosity (IV) of the polyester was measured according to ASTM D4603-96.

Measurement of Carboxyl End-Groups in Polyethylene Terephthalate—The method for the determination of carboxyl end-groups involves the addition of a measured excess of ethanolic sodium hydroxide to a solution of the polyester in o-cresol/chloroform and the potentiometric titration (using Metrohm 716 Titrino) of the excess. The titration was automatic, the titrant being added at a known rate over a period of 10-20 minutes.

Measurement of Diethylene Glycol Groups in Polyethylene Terephthalate by Gas Chromatography—The polymer sample was hydrolysed by agitation under reflux with potassium hydroxide in propan-1-ol in the presence of a known concentration of the internal standard (butane 1:4 diol). The hydrolysate was cooled, neutralised with powdered terephthalic acid and the clarified liquor subjected to a gas chromatograph (Perkin Elmer Autosystem GC fitted with a flame ionisation detector, on column injection facility, PSS injector and configured with capillary column parameters. The peak area ratio of the diethylene glycol to the internal marker was obtained from the chromatogram. The results were calculated by reference to a calibration factor and are reported to the nearest 0.01% w/w.

Measurement of Acetaldehyde Level in Polyethylene Terephthalate Chip and Preforms by Thermal Desorption Gas Chromatography.—The sample was ground to a powder, weighed and packed into a thermal desorption tube. Acetaldehyde was desorbed from the sample by heating the tube at 160° C. with a stream of nitrogen passing through the sample for 10 minutes. The acetaldehyde was held in a cold trap and released into the chromatograph after the 10 minute desorption period. The acetaldehyde was analysed on a Gas Chromatograph Perkin Elmer 8000 system comprising a column packed with Porapak “QS” and a flame ionisation detector. Quantification was carried out by measurement of peak areas and relating to those of appropriate standards to obtain ppm w/w acetaldehyde based on the weight of polymer taken for desorption.

Measurement of Element content in Polyethylene Terephthalate—The element content of the polymer sample was measured with a SpectroFlame Modula E inductively coupled plasma—atomic emission spectrometer (ICP/AES) manufactured by Spectro GmbH, Germany. The sample was dissolved by microwave assisted digestion in a 1:1 mixture of concentrated sulfuric acid and concentrated nitric acid. After cooling, the digestion was diluted with pure water and subsequently analyzed. Comparison of atomic emissions from the sample under analysis with those of certified standard solutions of known metal ion concentrations was used to determine the experimental values of metals retained in the polymer sample.

Measurement of Vinyl-End Groups in Polyethylene Terephthalate—This was done by NMR analysis by a third party (Intertek MSG, UK).

### EXAMPLES

The following examples were run on a 1 metric tonne per day continuous pilot line facility incorporating four reactors with multiple inter-vessel additive injection points and a post-finisher transfer line injection point.

Unless otherwise specified, in all the examples: The first reactor or primary esterifier (PE) was fed with a 1.1:1 terephthalic acid (TA):ethylene glycol (EG) paste, operated at supra-atmospheric pressures with a reactor residence time of about two hours and a temperature range of 255° C. to 270° C. The second reactor or secondary esterifier (SE) had a residence time of about one hour, operated at atmospheric pressure and a temperature range of 260° C. to 280° C. Any additives were injected between the second and third reactors. Additives can include toners and non-late addition phosphorous compounds. The third reactor or low polymeriser (LP) was operated under sub-atmospheric pressures of about 50 mBara, had a residence time of about 40 minutes and operated in the temperature range of 270° C. to 285° C. The final reactor or high polymeriser (HP) operated under vacuum control whereby the operating pressure was dictated by the viscosity of the final product, typically this was about 1 mBara. The final reactor residence time was about one hour and operated in a temperature range of 270° C. to 285° C. The anhydride compounds were added into the polymer transfer line in the melt phase between the final reactor and the underwater strand cutter.

Unless otherwise specified, in all examples: The primary esterifier was a forced recirculating vessel with a rectification column overhead. Ethylene glycol (EG) vapour was condensed in the rectification column and returned to the vessel. Water vapour passed through the column and was subsequently condensed thereby driving the esterification reaction to around 90% completion. The remaining reactors were horizontal wiped-wall vessels from which the EG and water vapours were condensed and either recirculated to paste formation or collected for disposal.

Unless otherwise specified, in all examples: The polyester resin made as outlined above was then precrystallised in an air oven for about 20 minutes at about 170° C. then de-aldehydised at about 175° C. in air for about six hours during which time the chip crystallinity increased to more than 35% (calculation from delta H (fusion)) and the residual aldehyde content fell to less than 1 ppm. Alternatively, the polymer can be de-AA'd in a nitrogen driven fluid bed or in a commercial-scale recirculating air oven.

The resulting polymer in each example was subjected to various standard PET analytical measurements including intrinsic viscosity (IV), carboxyl end group analysis (CEG), hydroxyl end group analysis (HEG), ICP elemental analysis for metals, Acetaldehyde (AA) level analysis and vinyl-end group analysis (VEG). AA formed is related to HEG plus VEG concentrations. Therefore, with a constant VEG, a reduction in HEG will result in lower AA.

The polymer was also injection moulded into preforms using two different pieces of industrial scale equipment, either an Arburg or an Negro Bossi (NB90). The Arburg preform moulding equipment was a single cavity machine with a 270° C. moulding temperature with a cycle time of about 23 seconds. The NB90 preforom moulding equipment was a single cavity machine with a 275° C. moulding temperature with a cycle time of about 43 seconds. The preform AA was measured using one or both of these machines and recorded.

### Comparative Example 1

In this example a preform AA value was established without SSP and without anhydride using an antimony catalyst system and a throughput/flow of 40 kg/hour. Phosphorous in the form of phosphoric acid was added to the oligomer line before the LP along with cobalt as a toner. The antimony catalyst was added to the paste makeup in the PE. No anhydride was added. Detailed process conditions and measurement results are in Table 1.

TABLE 1

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 280 | C. |
| LP Pressure | 50 | mBara |
| LP level | 60 | % |
| LP IV | 0.295 | dl/g |
| HP Temp | 280 | C. |
| HP Pressure | 3.9 | mBara |
| HP level | 55 | % |
| HP IV | 0.609 | dl/g |
| HP CEG | 27 | microeq/g |
| HP VEG | 0.012 | mol/100 rpt unit |
| HP AA | 42 | ppm |
| Sb | 280 | ppm |
| Ti | 0 | ppm |
| P | 7.5 | ppm |
| Co | 15 | ppm |
| L | 65 | CIE |
| B | 1.1 | CIE |
| SSP IV | 0.823 | dl/g |
| SSP b | 0.23 | CIE |
| Arburg AA | 7.4 | ppm |
| Arburg b | 3.05 | CIE |

### Comparative Example 2

In this example an HP HEG value and a preform AA value were established without SSP and without anhydride using antimony catalyst and a throughput/flow of 20 kg/hour. The plant throughput is reduced to keep the VEGs low by maintaining a low HP temperature compared to Comparative Example 1. The antimony and phosphorous/cobalt addition points are as for Comparative Example 1. No anhydride was added. Detailed process conditions and measurement results are in Table 2.

TABLE 2

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 1.2 | mBara |
| HP level | 55 | % |
| HP IV | 0.827 | dl/g |
| HP CEG | 23 | microeq/g |
| HP VEG | 0.006 | mol/100 rpt unit |
| HP HEG | 0.76 | mol/100 rpt unit |
| HP AA | 35 | ppm |
| Sb | 280 | ppm |
| SA | 0 | % w/w |
| PA | 0 | % w/w |
| P | 30 | ppm |
| Co | 60 | ppm |
| L | 59.9 | CIE |
| b | 1.1 | CIE |
| Arburg AA | 8.2 | ppm |
| Arburg b | 2.68 | CIE |

The preform AA is 8.2 ppm with polymer VEGs of 0.006, HEGs of 0.76.

### Example 3

In this example 0.3% w/w succinnic anhydride (SA) was added to the polymer transfer line at the throughput/flow of 20 kg/hour. Phosphorous in the form of phosphoric acid was added to the oligomer line before the LP along with cobalt as a toner. The antimony catalyst was added to the paste makeup in the PE. The HP temperature is 271 C. Detailed process conditions and measurement results are in Table 3.

TABLE 3

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 1.0 | mBara |
| HP level | 55 | % |
| HP IV | 0.822 | dl/g |
| HP CEG | 48.3 | microeq/g |
| HP VEG | 0.009 | mol/100 rpt unit |
| HP HEG | 0.42 | mol/100 rpt unit |
| Sb | 280 | ppm |
| SA | 0.3 | % w/w |
| PA | 0 | % w/w |
| P | 30 | ppm |
| Co | 60 | ppm |
| L | 60.3 | CIE |
| b | 1.1 | CIE |

The HP HEGs are reduced as compared to Comparative Example 2, indicating an anticipated reduction in perform AA. The succinnic anhydride reacts with HEGs to make CEGs, therefore CEGs increase with increasing succinnic anhydride.

### Example 4

In this example the succinnic anhydride (SA) content was increased to 0.6% w/w with the same process conditions as in Example 3. Detailed process conditions and measurement results are in Table 4.

TABLE 4

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 1 | mBara |
| HP level | 55 | % |
| HP IV | 0.825 | dl/g |
| HP CEG | 77.8 | microeq/g |
| HP VEG | 0.009 | mol/100 rpt unit |
| HP HEG | 0.24 | mol/100 rpt unit |
| Sb | 280 | ppm |
| SA | 0.6 | % w/w |
| PA | 0 | % w/w |
| P | 30 | ppm |
| Co | 60 | ppm |
| L | 60.2 | CIE |
| b | 1.8 | CIE |

Again, the HP HEGs are reduced as compared to Comparative Example 2, indicating an anticipated reduction in preform AA.

### Example 5

In this example the succinnic anhydride (SA) content was increased to 0.9% w/w with the same process conditions as in Example 3. Detailed process conditions and measurement results are in Table 5.

TABLE 5

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 0.9 | mBara |
| HP level | 55 | % |
| HP IV | 0.819 | dl/g |
| HP CEG | 98.2 | microeq/g |
| HP VEG | 0.009 | mol/100 rpt unit |
| HP HEG | 0.24 | mol/100 rpt unit |
| HP AA | 29 | ppm |
| Sb | 280 | ppm |
| SA | 0.9 | % w/w |
| PA | 0 | % w/w |
| P | 30 | ppm |
| Co | 60 | ppm |
| L | 60.1 | CIE |
| b | 2.6 | CIE |
| Arburg AA | 4.2 | ppm |
| Arburg b | 8.6 | CIE |

As compared to Comparative Examples 1 and 2, the preform AA is reduced and this correlates to the lower HP HEG levels of 0.24 above.

### Example 6

In this example 0.6% w/w phthallic anhydride (PA) was added to the polymer transfer line and the plant rate was a throughput/flow of 20 kg/hour. Phosphorous in the form of phosphoric acid was added to the oligomer line before the LP along with cobalt as a toner. The antimony catalyst was added to the paste makeup in the PE. Detailed process conditions and measurement results are in Table 6.

TABLE 6

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 1 | mBara |
| HP level | 55 | % |
| HP IV | 0.819 | dl/g |
| HP CEG | 56.4 | microeq/g |
| HP VEG | 0.008 | mol/100 rpt unit |
| HP HEG | 0.6 | mol/100 rpt unit |
| Sb | 280 | Ppm |
| SA | 0 | % w/w |
| PA | 0.6 | % w/w |
| P | 30 | Ppm |
| Co | 60 | Ppm |
| L | 60.1 | CIE |
| b | 1 | CIE |

The HP HEGs are reduced as compared to Comparative Example 2, indicating an anticipated reduction in perform AA.

### Example 7

In this example the phthallic anhydride (PA) content was increased to 1.2% w/w with the same process conditions as in Example 6. Detailed process conditions and measurement results are in Table 7.

TABLE 7

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 0.8 | mBara |
| HP level | 55 | % |
| HP IV | 0.804 | dl/g |
| HP CEG | 92.8 | microeq/g |
| HP VEG | 0.009 | mol/100 rpt unit |
| HP HEG | 0.5 | mol/100 rpt unit |
| Sb | 280 | ppm |
| SA | 0 | % w/w |
| PA | 1.2 | % w/w |
| P | 30 | ppm |
| Co | 60 | ppm |
| L | 60.2 | CIE |
| b | 1.2 | CIE |

Again, the HP HEGs are reduced as compared to Comparative Example 2, indicating an anticipated reduction in perform AA.

### Example 8

In this example the phthallic anhydride (PA) content was increased to 1.8% w/w with the same process conditions as in Example 6. Detailed process conditions and measurement results are in Table 8.

TABLE 8

| Parameter | Value | Units |
|---|---|---|
| TA:EG mole ratio | 1.07:1 | |
| PE Temp | 260 | C. |
| PE Pressure | 3.5 | Barg |
| PE level | 40 | % |
| SE Temp | 265 | C. |
| SE Pressure | 960 | mBara |
| SE level | 30 | % |
| LP Temp | 270 | C. |
| LP Pressure | 60 | mBara |
| LP level | 50 | % |
| LP IV | 0.269 | dl/g |
| HP Temp | 271 | C. |
| HP Pressure | 0.7 | mBara |
| HP level | 55 | % |
| HP IV | 0.807 | dl/g |
| HP CEG | 122.1 | microeq/g |
| HP VEG | 0.009 | mol/100 rpt unit |
| HP HEG | 0.5 | mol/100 rpt unit |
| HP AA | 33 | ppm |
| Sb | 280 | ppm |
| SA | 0 | % w/w |
| PA | 1.8 | % w/w |
| P | 30 | ppm |
| Co | 60 | ppm |
| L | 60.2 | CIE |
| b | 1.2 | CIE |

Again, the HP HEGs are reduced as compared to Comparative Example 2, indicating an anticipated reduction in perform AA.

### Comparative Example 9

In this example the plant rate was increased to 40 kgph, the PE, SE and LP levels were increased, the TA:EG mole ratio was increased and the SE, LP and HP temperatures were increased. An HP HEG value and a preform AA value were established without SSP and without anhydride at these rates, levels and temperatures using antimony catalyst. Phosphorous in the form of phosphoric acid was added to the oligomer line before the LP along with cobalt as a toner. The antimony catalyst was added to the paste makeup in the PE. The HP was operated at 292 C. The polymer colour was controlled by increasing the Co level to 65 ppms. No anhydride was added. Detailed process conditions and measurement results are in Table 9.

TABLE 9

| Parameter | Value | Units |
|---|---|---|
| TA:EG mole ratio | 1.13:1 | |
| PE Temp | 260 | C. |
| PE Pressure | 3.5 | Barg |
| PE level | 80 | % |
| SE Temp | 267 | C. |
| SE Pressure | 960 | mBara |
| SE level | 40 | % |
| LP Temp | 270 | C. |
| LP Pressure | 60 | mBara |
| LP level | 55 | % |
| LP IV | 0.234 | dl/g |
| HP Temp | 292 | C. |
| HP Pressure | 0.7 | mBara |
| HP level | 55 | % |
| HP IV | 0.803 | dl/g |
| HP CEG | 25.8 | microeq/g |
| HP VEG | 0.028 | mol/100 rpt unit |
| HP HEG | 0.62 | mol/100 rpt unit |
| HP AA | 80 | ppm |
| Sb | 280 | ppm |
| SA | 0 | % w/w |
| PA | 0 | % w/w |
| P | 33 | ppm |
| Co | 65 | ppm |
| L | 59 | CIE |
| B | 0.6 | CIE |
| Arburg AA | 22 | ppm |
| Arburg b | 2.63 | CIE |

### Example 10

In this example the plant rate was increased to 40 kgph (as in Comparative Example 9) by increasing the PE, SE and LP levels, increasing the TA:EG mole ratio and increasing the SE, LP and HP temperatures. Phosphorous in the form of phosphoric acid was added to the oligomer line before the LP along with cobalt as a toner. The antimony catalyst was added to the paste makeup in the PE. The HP was operated at 292 C. The polymer colour was controlled by increasing the Co level to 65 ppms. Succinnic anhydride (SA) was added at a concentration of 0.3% w/w to the transfer line. Detailed process conditions and measurement results are in Table 10.

TABLE 10

| Parameter | Value | Units |
|---|---|---|
| TA:EG mole ratio | 1.13:1 | |
| PE Temp | 260 | C. |
| PE Pressure | 3.5 | Barg |
| PE level | 80 | % |
| SE Temp | 267 | C. |
| SE Pressure | 960 | mBara |
| SE level | 40 | % |
| LP Temp | 270 | C. |
| LP Pressure | 60 | mBara |
| LP level | 55 | % |
| LP IV | 0.234 | dl/g |
| HP Temp | 292 | C. |
| HP Pressure | 0.4 | mBara |
| HP level | 55 | % |
| HP IV | 0.798 | dl/g |
| HP CEG | 59.5 | microeq/g |
| HP VEG | 0.034 | mol/100 rpt unit |
| HP HEG | 0.32 | mol/100 rpt unit |
| HP AA | 80 | ppm |
| Sb | 280 | ppm |
| SA | 0.3 | % w/w |
| PA | 0 | % w/w |
| P | 33 | ppm |
| Co | 65 | ppm |
| L | 58.1 | CIE |
| b | 0.35 | CIE |

The HP HEGs are reduced as compared to Comparative Example 9, indicating an anticipated reduction in perform AA.

### Example 11

In this example the succinnic anhydride (SA) was added at a concentration of 0.6% w/w to the transfer line with the same process conditions as in Example 10. Detailed process conditions and measurement results are in Table 11.

TABLE 11

| Parameter | Value | Units |
|---|---|---|
| TA:EG mole ratio | 1.13:1 | |
| PE Temp | 260 | C. |
| PE Pressure | 3.5 | Barg |
| PE level | 80 | % |
| SE Temp | 267 | C. |
| SE Pressure | 960 | mBara |
| SE level | 40 | % |
| LP Temp | 270 | C. |
| LP Pressure | 60 | mBara |
| LP level | 55 | % |
| LP IV | 0.234 | dl/g |
| HP Temp | 292 | C. |
| HP Pressure | 0.25 | mBara |
| HP level | 55 | % |
| HP IV | 0.804 | dl/g |
| HP CEG | 84.5 | microeq/g |
| HP VEG | 0.036 | mol/100 rpt unit |
| HP HEG | 0.15 | mol/100 rpt unit |
| Sb | 280 | ppm |
| SA | 0.6 | % w/w |
| PA | 0 | % w/w |
| P | 33 | ppm |
| Co | 65 | ppm |
| L | 58.3 | CIE |
| b | 3.5 | CIE |

Again, the HP HEGs are reduced as compared to Comparative Example 9, indicating an anticipated reduction in perform AA.

### Example 12

In this example the succinnic anhydride (SA) was added at a concentration of 0.9% w/w to the transfer line with the same process conditions as in Example 10. Detailed process conditions and measurement results are in Table 12.

TABLE 12

| Parameter | Value | Units |
|---|---|---|
| TA:EG mole ratio | 1.13:1 | |
| PE Temp | 260 | C. |
| PE Pressure | 3.5 | Barg |
| PE level | 80 | % |
| SE Temp | 267 | C. |
| SE Pressure | 960 | mBara |
| SE level | 40 | % |
| LP Temp | 270 | C. |
| LP Pressure | 60 | mBara |
| LP level | 55 | % |
| LP IV | 0.234 | dl/g |
| HP Temp | 292 | C. |
| HP Pressure | 0.15 | mBara |
| HP level | 55 | % |
| HP IV | 0.797 | dl/g |
| HP CEG | 113.2 | microeq/g |
| HP VEG | 0.036 | mol/100 rpt unit |
| HP HEG | 0.12 | mol/100 rpt unit |
| HP AA | 54 | ppm |
| Sb | 280 | ppm |
| SA | 0.9 | % w/w |
| PA | 0 | % w/w |
| P | 33 | ppm |
| Co | 65 | ppm |
| L | 58.2 | CIE |
| B | 7.2 | CIE |
| Arburg AA | 5.5 | ppm |
| Arburg b | 18.46 | CIE |

This demonstrates a low perform AA as compared to Comparative Example 9 even with the high VEG level.

### Example 13

In this example the succinnic anhydride (SA) was added at a concentration of 0.9% w/w to the transfer line with a polymer flowrate of 30 kgph. Phosphorous in the form of phosphoric acid was added to the oligomer line before the LP along with cobalt as a toner. The antimony catalyst was added to the paste makeup in the PE. The HP temperature was 283 C. Preforms are molded on both the Arburg and Negro Bossi NB90 machines in order to compare results. Detailed process conditions and measurement results are in Table 13.

TABLE 13

| Parameter | Value | Units |
|---|---|---|
| TA:EG mole ratio | 1.1:1 | |
| PE Temp | 260 | C. |
| PE Pressure | 3.5 | Barg |
| PE level | 75 | % |
| SE Temp | 265 | C. |
| SE Pressure | 960 | mBara |
| SE level | 35 | % |
| LP Temp | 270 | C. |
| LP Pressure | 50 | mBara |
| LP level | 55 | % |
| LP IV | 0.255 | dl/g |
| HP Temp | 283 | C. |
| HP Pressure | 0.6 | mBara |
| HP level | 50 | % |
| HP IV | 0.804 | dl/g |
| HP CEG | 124 | microeq/g |
| HP VEG | 0.019 | mol/100 rpt unit |
| HP HEG | 0.16 | mol/100 rpt unit |
| HP AA | 40 | ppm |
| Sb | 280 | ppm |
| SA | 0.9 | % w/w |
| PA | 0 | % w/w |
| P | 33 | ppm |
| Co | 65 | ppm |
| L | 59.4 | CIE |
| b | 3.4 | CIE |
| Arburg AA | 4.1 | ppm |
| Arburg b | 10.98 | CIE |
| NB90 AA | 18.8 | ppm |

The NB90 machine gives a significantly higher preform AA value as a consequence of its longer cycle time.

### Example 14

In this example the succinnic anhydride (SA) was added at a concentration of 0.2% w/w to the transfer line with a polymer flowrate of 40 kgph. The catalyst was 70 ppm zinc acetate (Zn) with a co-catalyst of 12 ppm titanium (PC64 available from DuPont). Dyes were used to tone. The dyes used were Clariant Polysynthrin Blue RLS and Red 5B. The HP temperature was 275 C. The phosphorous compound was tributyl phosphate (TBP). The phosphorous was added to the oligomer line before the LP along with the dyes as a toner. The titanium and zinc catalyst was added to the paste makeup in the PE. Detailed process conditions and measurement results are in Table 14.

TABLE 14

| Parameter | Value | Units |
|---|---|---|
| TA:EG mole ratio | 1.1:1 | |
| PE Temp | 265 | C. |
| PE Pressure | 3.5 | Barg |
| PE level | 80 | % |
| SE Temp | 270 | C. |
| SE Pressure | 960 | mBara |
| SE level | 40 | % |
| LP Temp | 270 | C. |
| LP Pressure | 50 | mBara |
| LP level | 50 | % |
| LP IV | 0.292 | dl/g |
| HP Temp | 275 | C. |
| HP Pressure | 0.6 | mBara |
| HP level | 50 | % |
| HP IV | 0.822 | dl/g |
| HP CEG | 34.7 | microeq/g |
| HP AA | 47 | ppm |
| Sb | 0 | ppm |
| SA | 0.2 | % w/w |
| PA | 0 | % w/w |
| Zn | 70 | ppm |
| Ti | 18 | ppm |
| P | 100 | ppm |
| Co | 0 | ppm |
| L | 51.8 | CIE |
| b | 0.3 | CIE |
| NB90 AA | 2.54 | ppm |
| NB90 b* | 2.1 | CIE |

This AA level is reduced as compared to Comparative Examples 1-2 (by cross reference of Arburg to NB90 via Example 13).

While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

What is claimed is:

1. A process for producing a polyester comprising:
(a) forming a polyester in a melt phase having an intrinsic viscosity of about 0.65 or more, provided that said forming is not by solid state polymerization; and
(b) adding an anhydride to the polyester during the melt phase.

2. The process of claim 1 wherein said intrinsic viscosity is about 0.70 or more.

3. The process of claim 1 wherein said intrinsic viscosity is about 0.75 or more.

4. The process of claim 1 wherein said intrinsic viscosity is about 0.80 or more.

5. The process of claim 1, wherein said anhydride is at least one member selected from the group consisting of succinic anhydride, substituted succinic anhydride, glutaric anhydride, substituted glutaric anhydride, phthalic anhydride, substituted phthalic anhydride, and maleic anhydride, substituted maleic anhydride and mixtures thereof.

6. The process of claim 5, wherein said substituted succinic anhydride is at least one member selected from the group consisting of methyl succinic anhydride, 2,2-dimethyl succinic anhydride, phenyl succinic anhydride, octadecenyl succinic anhydride, hexadecenyl succinic anhydride, eicosodecenyl succinic anhydride, 2-methylene succinic anhydride, n-octenyl succinic anhydride, nonenyl succinic anhydride, tetrapropenyl succinic anhydride, dodecyl succinic anhydride, and mixtures thereof.

7. The process of claim 5, wherein said substituted glutaric anhydride is at least one member selected from the group consisting of 3-methyl glutaric anhydride, phenyl glutaric anhydride, diglycolic anhydride, 2-ethyl 3-methyl glutaric anhydride, 3,3-dimethyl glutaric anhydride, 2,2-dimethyl glutaric anhydride, 3,3-tetramethylene glutaric anhydride, and mixtures thereof.

8. The process of claim 5, wherein said substituted phthalic anhydride is at least one member selected from the group consisting of 4-methyl phthalic anhydride, 4-t-butyl phthalic anhydride, tetrahydrophthalic anhydride, hexahydrophthalic anhydride, and mixtures thereof.

9. The process of claim 5, wherein said substituted maleic anhydride is at least one member selected from the group consisting of 2-methyl maleic anhydride, 3,4,5,6-tetrahydrophthalic anhydride, 1-cyclopentene-1,2-dicarboxylic anhydride, dimethyl maleic anhydride, diphenyl maleic anhydride, and mixtures thereof.

10. The process of claim 1, wherein the anhydride is present at a concentration of from about 100 ppm to about 20,000 ppm based on weight of polymer.

11. The process of claim 1, wherein said anhydride has a melting point of about 250° C. or less.

12. The process of claim 1, wherein said forming of the polyester comprises use of a catalyst.

13. The process of claim 12, wherein the catalyst comprises at least one member selected from the group consisting of antimony, titanium, cobalt, zinc, germanium, aluminum and mixtures thereof.

14. The process of claim 13 wherein said catalyst comprises antimony.

15. The process of claim 14 wherein the antimony is present at a concentration in the range of from about 1 ppm to about 300 ppm by weight of the polyester.

16. The process of claim 13 wherein said catalyst comprises a mixture of titanium and zinc.

17. The process of claim 16 wherein the titanium and the zinc are present at a weight ratio in the range of from about 1:60 to about 1:2.

18. The process of claim 13 wherein the titanium is present at a concentration in the range of from about 3 ppm to about 50 ppm by weight of the polyester.

19. The process of claim 13 wherein the zinc is present at a concentration in the range of from about 60 ppm to about 250 ppm by weight of the polyester.

20. The process of claim 13 wherein the cobalt is present at a concentration in the range of from about 50 ppm to about 250 ppm by weight of the polyester.

21. The process of claim 1 wherein said polyester is produced by the polycondensation of a diol and a diacid; said diol is selected from the group consisting of ethylene glycol, 1,3-propane diol, 1,4-butane diol and 1,4-cyclohexanedimethanol; and said diacid is selected from the group consisting of terephthalic acid, isophthalic acid and 2,6-naphthoic acid.

22. The process of claim 21 wherein said polyester is at least one member selected from the group consisting of polyethylene terephthalate, polyethylene naphthalate, polyethylene isophthalate, polybutylene terephthalate, copolyesters of polyethylene terephthalate, copolyesters of polyethylene naphthalate, copolyesters of polyethylene isophthalate, copolyesters of polybutylene terephthalate and mixtures thereof.

23. The process of claim 22 wherein said polyester is polyethylene terephthalate or a copolyester of polyethylene terephthalate with up to 20 wt-% of isophthalic acid or 2,6-naphthoic acid, and up to 10 wt-% of diethylene glycol or 1,4-cyclohexanedimethanol.

24. The process of claim 22 wherein said polyester is polybutylene terephthalate or a copolyester of polybutylene terephthalate with up to 20 wt-% of a dicarboxylic acid, and up to 20 wt-% of ethylene glycol or 1,4-cyclohexanedimethanol.

25. The process of claim 22 wherein said polyester is polyethylene naphthalate or a copolyester of polyethylene naphthalate with up to 20 wt-% of isophthalic acid, and up to 10 wt-% of diethylene glycol or 1,4-cyclohexanedimethanol.

26. The process of claim 1 further comprising step (c) removing volatile components from the polyester.

27. A process for producing a polymeric material comprising:
(a) forming a polymeric material with an intrinsic viscosity of about 0.65 or more, provided that said forming is not by solid state polymerization;
(b) adding an anhydride to the polymeric material in the melt phase;
(c) removing volatile components from the polymeric material;
(d) drying the polymeric material; and
(e) injection molding the polymeric material.

28. A process for producing a polyester comprising:
(a) forming a polymeric material with an intrinsic viscosity of about 0.65 or more, provided that said forming is not by solid state polymerization; and
(b) adding an anhydride to the polyester during the melt phase
wherein the forming of step (a) and adding of step (b) are performed at a temperature in the range of from about 270° C. to about 300° C.

29. The process of claim 28, wherein the forming of step (a) and adding of step (b) are performed at a temperature in the range of from about 290° C. to about 300° C.

30. The process of claim 1 further comprising adding an additive.

31. The process of claim 30 wherein the additive comprises at least one member selected from the group consisting of a heat stabilizer, an anti-blocking agent, an antioxidant, an antistatic agent, a UV absorber, a pigment, a dye, a filler, a branching agent and mixtures thereof.

32. An article comprising a composition produced by the process of claim 1, 27 or 28.
